(19) United States
(12) Patent Application Publication
(10) Pub. No.: US 2016/0050716 A1
(43) Pub. Date: Feb. 18, 2016

(54) Temperature controlling heating device

(71) Applicant: Shin-Ping Peng, Taipei City (TW)

(72) Inventor: Shin-Ping Peng, Taipei City (TW)

(21) Appl. No.: 14/583,515

(22) Filed: Dec. 26, 2014

(30) Foreign Application Priority Data
Aug. 15, 2014 (TW) 103214537

(51) Int. Cl. H05B 1/02; A41D 13/005

(52) U.S. Cl. CPC H05B 1/0272; A41D 13/0051

(57) ABSTRACT

A temperature controlling heating device, comprising a heating piece, a temperature controlling means, which is electrically connected to the heating piece, including a temperature adjusting element, a temperature displaying element and a microprocessor, wherein the temperature adjusting element and the temperature displaying element are disposed on a surface of the temperature controlling means, the microprocessor is disposed within the temperature controlling means and is electrically connected to the temperature adjusting element, the temperature displaying element and the heating piece, the temperature adjusting element is provided to adjust temperature of the heating piece with the microprocessor in respond to a user's input, and a battery electrically connected to the temperature controlling means and the heating piece to provide electrical power for the temperature controlling means and the heating piece.

### FIELD OF THE INVENTION

The present invention relates to a heating device, and more particularly to a heating device which controls temperature.

### BACKGROUND OF THE INVENTION

People tend to wear heavy clothes to keep warm in winter, but wearing heavy clothes could make people feel uncomfortable. Further, heavy clothing storage would result in much inconvenience. Therefore, manufacturers have developed such heat preservation articles as hand warmer packs, etc. to provide heat. However, these articles can merely retain heat in certain body parts apart from inability to control the temperature. Moreover, they can also be used over a very short time period, thereby making them inadequate to provide heat retention efficiency people need.

### SUMMARY OF THE INVENTION

The present invention has been made in view of the above circumstances, and an object of the present invention is to provide a temperature heating device to solve the conventional problems.

To achieve the above object, the present invention provides a temperature controlling heating device, comprising: a heating piece; a temperature controlling means and a battery. The heating piece can be made of carbon fiber or alloy fiber. The temperature controlling means electrically connected to the heating piece includes a temperature adjusting element, a temperature displaying element and a microprocessor, wherein the temperature adjusting element and the temperature displaying element are disposed on a surface of the temperature controlling means, the microprocessor is disposed within the temperature controlling means and is electrically connected to the temperature adjusting element, the temperature displaying element and the heating piece, the temperature adjusting element is adjusted by a user to adjust the temperature of the temperature of the heating piece via the microprocessor, and a battery is electrically connected to the temperature controlling means and the heating piece so as to supply power to the temperature controlling means and the heating piece.

According to an embodiment of the present invention, there is provided a temperature controlling heating device further comprising an external temperature controlling means including: an external temperature adjusting element, an external temperature displaying element; an external microprocessor and an external wireless controlling transceiver. The external temperature adjusting element and the external temperature displaying element are disposed on a surface of the external temperature controlling means while the external microprocessor and the external wireless controlling transceiver are disposed within the external temperature controlling means. Further, the external microprocessor is electrically connected to the external temperature adjusting element and the external temperature displaying element; and an external wireless controlling transceiver is electrically connected to the external microprocessor and wirelessly connected to the temperature controlling means to receive or transmit a temperature controlling signal of the external microprocessor.

According to an embodiment of the present invention, the battery can be a dry battery or a lithium battery.

According to an embodiment of the present invention, the battery is disposed within the temperature controlling means.

According to an embodiment of the present invention, the temperature controlling means further includes an external power connecting element for electrically connected to an external power source.

According to an embodiment of the present invention, the external power source is a commercial power source.

According to an embodiment of the present invention, a temperature controlling signal can be a Bluetooth signal, a Wi-Fi signal or a radio frequency signal.

According to an embodiment of the present invention, the external temperature controlling means can be a mobile communication device, and an external temperature adjusting element can be a touch screen element.

According to an embodiment of the present invention, the external temperature adjusting element is a shaking element, which is provided for a user to adjust the temperature of the heating piece by shaking the external temperature adjusting element.

According to an embodiment of the present invention, the heating piece is further provided with a vibrator wirelessly connected to the external wireless controlling transceiver to receive an audio signal from the external temperature controlling means, and the vibrator performs a vibratory action according to the audio signal.

By way of the technical means adopted by the present invention, the heating piece could be disposed within a lining of textiles and the temperature thereof is controlled by the temperature controlling means. A user can adjust the temperature depending on personal needs. Further, the present invention uses the battery as a power source of the heating piece. As long as a replacement battery can continue to heat up, a user is thus provided with better heat retention efficiency and an extended period of use.

### BRIEF DESCRIPTION OF THE DRAWINGS

FIG. 1 is a block diagram illustrating a temperature controlling heating device according to a first embodiment of the present invention.

FIG. 2 is a block diagram illustrating a temperature controlling heating device according to a second embodiment of the present invention.

FIG. 3 is a three-dimensional diagram illustrating a heating pieces which is a fabric according to the first embodiment of the present invention.

FIG. 4 is a three-dimensional diagram illustrating a heating piece which is a facial mask according to the second embodiment of the present invention.

### DETAILED DESCRIPTION OF THE PREFERRED EMBODIMENTS

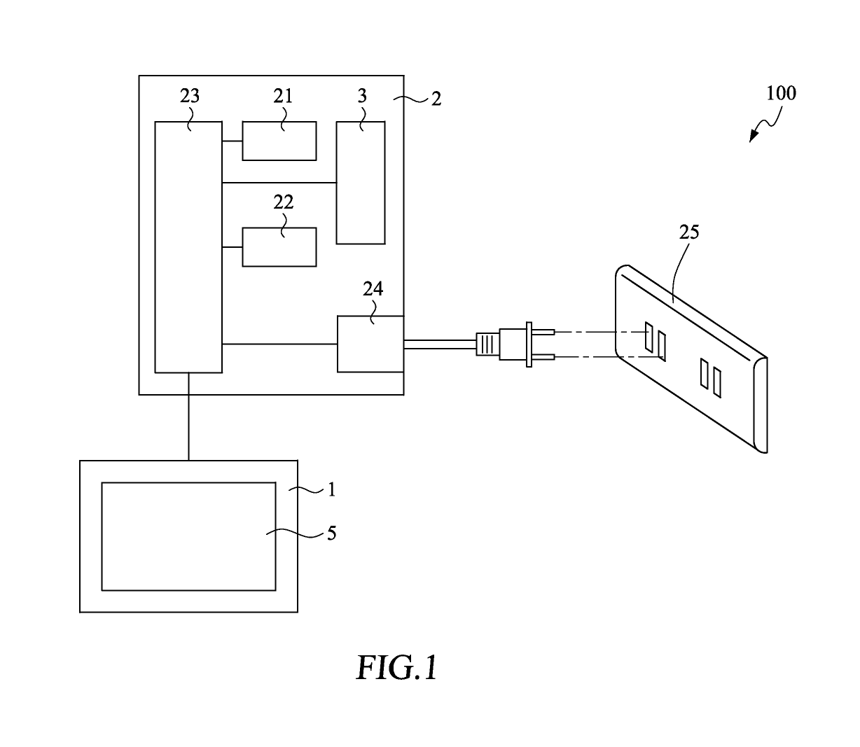

To clearly illustrate the object and effect of the present invention, the following description is explained with reference to FIGS. 1, 2, 3 and 4.

As shown in FIG. 1, the temperature controlling heating device 100 comprises a heating piece 1, a temperature controlling means 2, and a battery 3.

The heating piece 1 can be a heating piece made of carbon fiber or alloy fiber. The heating piece 1 disposed within a fabric 0. According to the first embodiment, the heating piece is disposed within a lining of a coat. The fabric O, however, is not limited to a coat. It can also be an upper garment, pants, gloves, socks of a facial mask. The heating piece 1 can also be disposed within linings of the aforementioned fabrics.

As shown in FIG. 1, a temperature controlling member 2 is electrically connected to the heating piece 1 to transmit power to the heating piece 1 and adjust the temperature of the heating piece 1. The temperature controlling member 2 includes a temperature adjusting element 21, a temperature displaying element 22 and a microprocessor 23. The temperature adjusting element 21 and the temperature displaying element 22 are disposed on a surface of the temperature controlling means 2. The microprocessor 23 is disposed within the temperature controlling means 2 and is electrically connected to the temperature adjusting element 21, the temperature displaying element 22 and the heating piece 1. The temperature adjusting element 21 is adjusted by a user to adjust the temperature of the heating piece 1 via the microprocessor 23. In practical operation, the user reads the temperature of heating piece 1 from the temperature displaying element 22. When the temperature is extremely low, the temperature of the heating piece 1 can be adjust through the temperature adjusting element 21. The microprocessor 23 correspondingly increase or decrease the current transferred to the heating piece 1 according to the temperature transmitted by the temperature adjusting element (21), thereby causing the temperature of the heating piece 1 to reach the temperature desired by the user.

As shown in FIG. 1, the battery 3 can be a dry battery or a lithium battery, which is disposed within the temperature controlling means 2. However, the present invention is not limited thereto. In other embodiments, the battery 3 can also be disposed within a mobile power source as well as electrically connected to the temperature controlling means 2 by way of external connection and supply the power needed by the microprocessor 23 and the heating piece 1. In the present embodiment, the temperature controlling means 2 further includes an external power connecting element 24 so as to be electrically connected to an external power source, which serves to recharge the battery 3. Alternatively, a commercial power source directly supplies power to the temperature controlling means 2 and the heating piece 1 when the battery 3 has insufficient power.

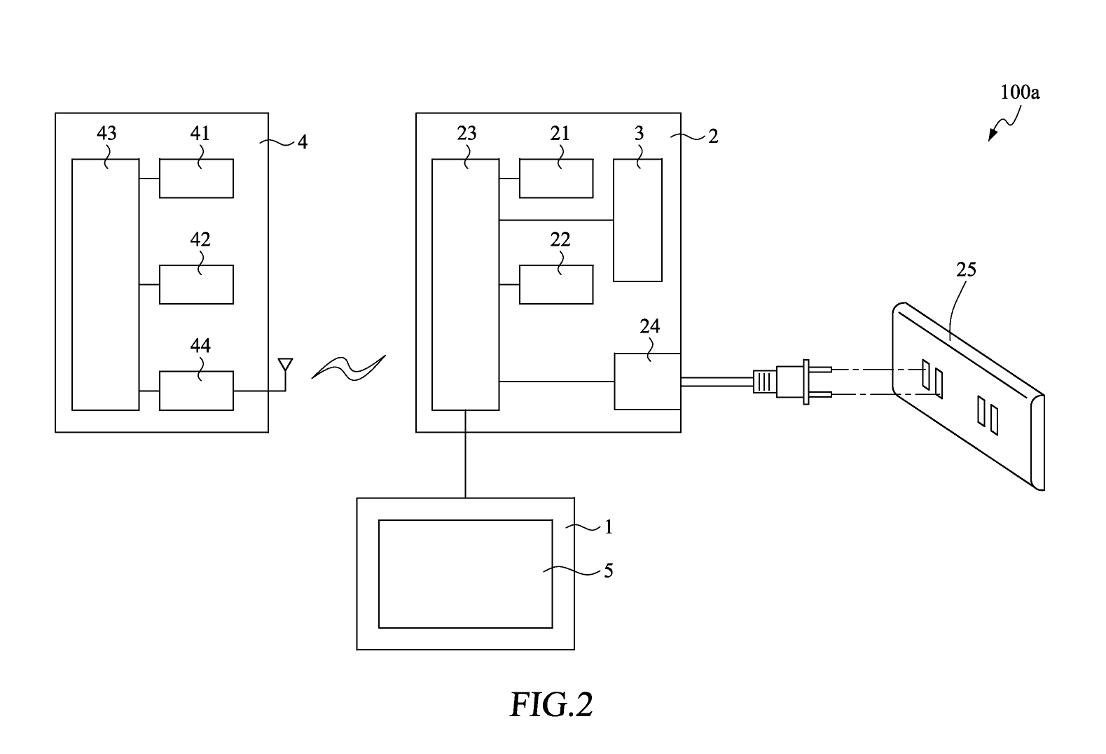

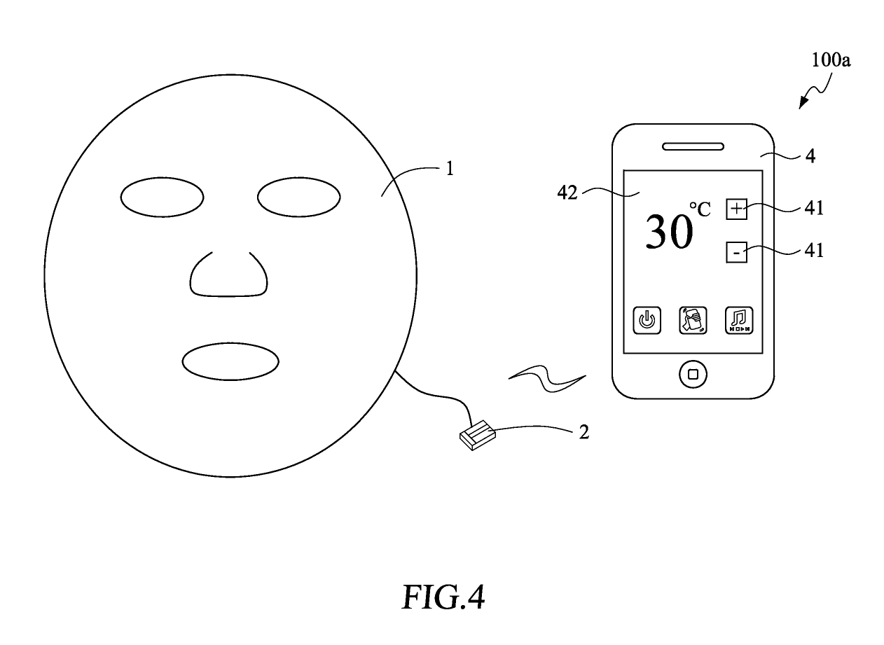

As shown in FIGS. 2 and 4, a temperature controlling heating device 100a according to another embodiment of present invention and the temperature controlling heating device 100 are roughly the same. The difference lie in the fact that the heating piece 1 of the temperature controlling heating device 100a is a facial mask, and the temperature controlling device 100a further includes an external temperature controlling means 4. The external temperature controlling means 4 is provided with an external temperature adjusting element 41, an external temperature displaying element 42, an external microprocessor 43 and an external wireless controlling transceiver 44. The external temperature adjusting element (41 is disposed on a surface of the external temperature controlling means 4. The external temperature displaying element 42 is disposed on the surface of the external temperature controlling means 4. The external microprocessor 43 is disposed within the external temperature controlling means (4 and electrically connected to the external temperature adjusting element 41 and the external temperature displaying element 42. The external wireless controlling transceiver 44 is disposed within the external temperature controlling means 4 and electrically connected to the external microprocessor 43 and wirelessly connected to the microprocessor 23 of the temperature controlling means 2 to receive or transmit a temperature controlling signal of the external microprocessor 43.

In this embodiment, a user. makes the external processor 43 generate a temperature controlling signal via operation of the external temperature adjusting element 41, and the temperature controlling signal is transmitted to the external wireless controlling transceiver 44. The external wireless controlling transceiver 44 transmits the temperature controlling signal to the microprocessor 23. The microprocessor 23 performs the temperature adjustment of the heating piece 1 via the temperature controlling signal. The external temperature displaying element 42 displays the target temperature.

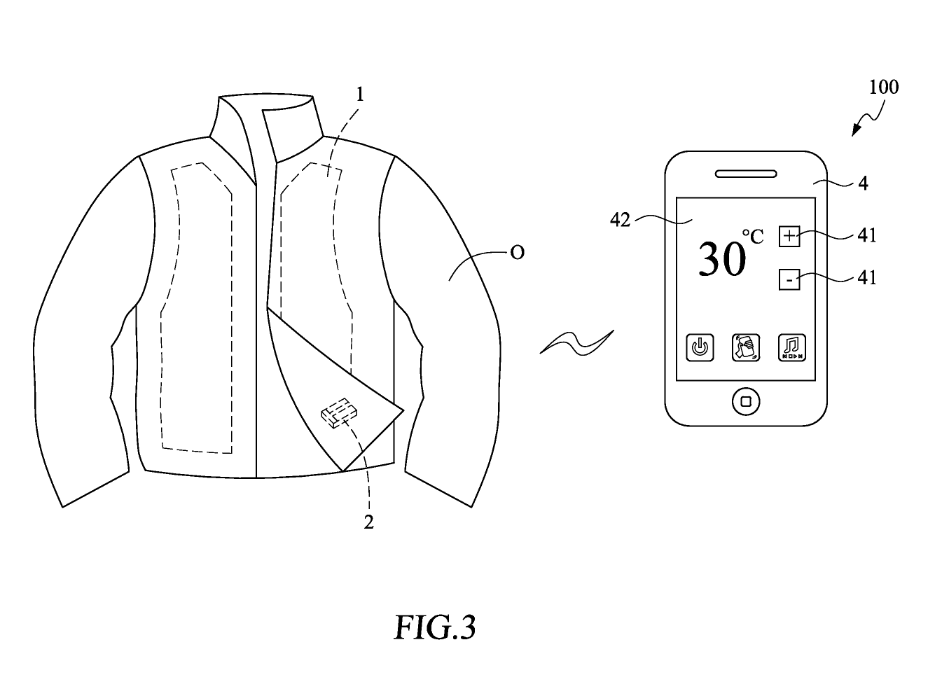

As shown in FIG. 3, in this embodiment, the external temperature controlling means 4 is a mobile communication device, such as a smart phone. Further, the external temperature adjusting element 41 is a touch control element, such as a touch screen of a smart phone. A temperature controlling signal is generated with the external temperature adjusting element 41 being controlled by a user's touch gestures and transmitted to the microprocessor 23. The microprocessor 23 adjusts the temperature of the heating piece 1 via the temperature controlling signal. The temperature controlling signal can be a Bluetooth signal, a Wi-Fi signal or a radio frequency signal. The temperature controlling means 2 can thereby correspond to the external temperature controlling means 4 by way of wireless transmission.

As shown in FIG. 4, the external temperature adjusting element 41 is a shaking element, such as a gravity sensor of a smart phone. When a user intends to adjust the temperature of the heating piece 1, he or she first switches the external temperature controlling means 4 to a shaking mode and then raises the temperature of the heating piece 1 via a shaking mode signal generated by shaking the external temperature adjusting element 41. For example, when the external temperature adjusting element 41 detects back-and-forth oscillation of the external temperature controlling means 4, the temperature of the heating piece 1 would be increased. If the external temperature adjusting element 41 senses an up-and-down oscillation of the external temperature controlling means 4) oscillates, the temperature of the heating piece 1 would be decreased. In this way, it is much easier for the user to control the temperature of the heating piece 1.

In addition, as shown in FIGS. 1 and 2, the heating piece 1 can be further provided with a vibrator 5 wirelessly connected to the external wireless controlling transceiver 44 to receive an audio signal generated from the external temperature controlling means 4. The vibrator 5 performs a vibratory action according to the audio signal in the first and the second embodiments. In practical operation, a user first switch the external temperature controlling means 4 to an audio vibration mode. The vibrator 5 of the heating piece 1 start vibrating via receipt of the audio signal generated by the external temperature controlling means 4, then achieving the effects of promoting blood circulation and massage.

The above is for describing preferable embodiments of the present invention, but not for limiting the present invention. Therefore, a person skilled in the art may make various modifications to the present invention. Those modifications still fall within the spirit and scope defined by the appended claims.

What is claimed is:

1. A temperature controlling heating device, comprising:
a heating piece;
a temperature controlling means, which is electrically connected to the heating piece, including a temperature adjusting element, a temperature displaying element and a microprocessor, wherein the temperature adjusting element and the temperature displaying element are disposed on a surface of the temperature controlling means, the microprocessor is disposed within the temperature controlling means and is electrically connected to the temperature adjusting element, the temperature displaying element and the heating piece, the temperature adjusting element is provided to adjust temperature of the heating piece with the microprocessor in respond to a user's input; and
a battery electrically connected to the temperature controlling means and the heating piece to provide electrical power for the temperature controlling means and the heating piece.

2. A temperature controlling heating device as claimed in claim 1, further comprising an external temperature controlling means, including:
an external temperature adjusting element provided at a surface of the external temperature controlling means;
an external temperature displaying element provided at the surface of the external temperature controlling means;
an external microprocessor provided within the external temperature controlling means and electrically connected to the external temperature adjusting element and the external temperature displaying element; and
an external wireless controlling transceiver provided within the external temperature controlling means and electrically connected to the external microprocessor and wirelessly connected to the temperature controlling means to receive or transmit a temperature controlling signal of the external microprocessor.

3. A temperature controlling heating device as claimed in claim 1, wherein the battery is a dry battery or a lithium battery.

4. A temperature controlling heating device as claimed in claim 1, wherein the battery is disposed within the temperature controlling means.

5. A temperature controlling heating device as claimed in claim 1, wherein the temperature controlling means further includes an external power connecting element for electrically connecting an external power source.

6. A temperature controlling heating device as claimed in claim 5, wherein the external power source is a commercial power source.

7. A temperature controlling heating device as claimed in claim 2, wherein the temperature controlling signal is a Bluetooth signal, a Wi-Fi signal or a radio frequency signal.

8. A temperature controlling heating device as claimed in claim 2, wherein the external temperature controlling means is a mobile communication device, and the external temperature adjusting element is a touch screen.

9. A temperature controlling heating device as claimed in claim 8, wherein the external temperature adjusting element is a shaking element, which is provided for a user to adjust the temperature of the heating piece by shaking the external temperature adjusting element.

10. A temperature controlling heating device as claimed in claim 8, wherein the heating piece is further provided with a vibrator, the vibrator is wirelessly connected to the external wireless controlling transceiver to receive an audio signal from the external temperature controlling mean, and the vibrator performs a vibration according to the audio signal.
